(19) United States
(12) Patent Application Publication
(10) Pub. No.: US 2013/0333984 A1
(43) Pub. Date: Dec. 19, 2013

(54) ELEVATOR CAB WALL PANEL

(71) Applicants: Christele Gressien, Chatillon Coligny (FR); Emmanuel Convard, La Bussiere (FR)

(72) Inventors: Christele Gressien, Chatillon Coligny (FR); Emmanuel Convard, La Bussiere (FR)

(73) Assignee: Otis Elevator Company, Farmington, CT (US)

(21) Appl. No.: 14/001,906

(22) PCT Filed: Mar. 4, 2011
(86) PCT No.: PCT/IB11/00718

§ 371 Date: Aug. 28, 2013

(51) Int. Cl. B66B 11/02; E04B 1/38; E04C 2/40

(52) U.S. Cl. CPC B66B 11/0253; E04C 2/40; E04B 1/38
USPC 187/401; 52/506.06; 52/745.21

(57) ABSTRACT

An exemplary elevator cab wall panel includes a plurality of panel members that are selectively moveable relative to each other to adjust the size of the panel. The panel is useful for selectively covering a space between a car operating panel and a nearby surface in an elevator cab. The wall panel provides a finished wall surface in the space.

### BACKGROUND

Elevator cabs carry passengers between the different levels in a building, for example. The interior of an elevator cab may be finished in a variety of styles. Many elevator cabs include a car operating panel that allows the passenger to select the floor to which she desires to be carried. The car operating panel is typically designed to have a finished look consistent with the interior of the cab.

When assembling elevator cabs, a variety of challenges may be presented. For example, it is sometimes necessary to design custom pieces to accommodate variations in cab size. Designing custom pieces for various cab sizes has the drawback of increasing costs and requiring a larger inventory of available components for installation personnel.

### SUMMARY

An exemplary elevator cab wall panel includes a plurality of panel members that are selectively moveable relative to each other to adjust the size of the panel. The panel is useful for selectively covering a space between a car operating panel and a nearby surface in an elevator cab. The wall panel provides a finished wall surface in the space.

An exemplary elevator cab includes a floor, a ceiling and a plurality of walls between the floor and ceiling. A car operating panel is supported on one of the walls with a space adjacent the car operating panel between the car operating panel and at least one of the floor or the ceiling. A wall panel includes a plurality of panel members that are selectively moveable relative to each other to adjust the size of the wall panel for selectively covering the space adjacent the car operating panel. The wall panel provides a finished wall surface in the space.

An exemplary method of covering a space between a car operating panel and a nearby surface in an elevator cab includes positioning a plurality of panel members between the car operating panel and the nearby surface. The panel members are then allowed to move relative to each other until the panel members cover the space and provide a finished surface for covering the space.

The various features and advantages of a disclosed embodiment of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator cab designed according to an embodiment of this invention.

FIG. 2 schematically illustrates an example wall panel designed according to an embodiment of this invention including panel members in a first position relative to each other.

FIG. 3 schematically illustrates the example wall panel of FIG. 2 with the panel members in a second position relative to each other.

FIG. 4 schematically illustrates selected features of the example of FIG. 2.

FIG. 5 schematically illustrates the selected features of FIG. 4 in another position.

### DETAILED DESCRIPTION

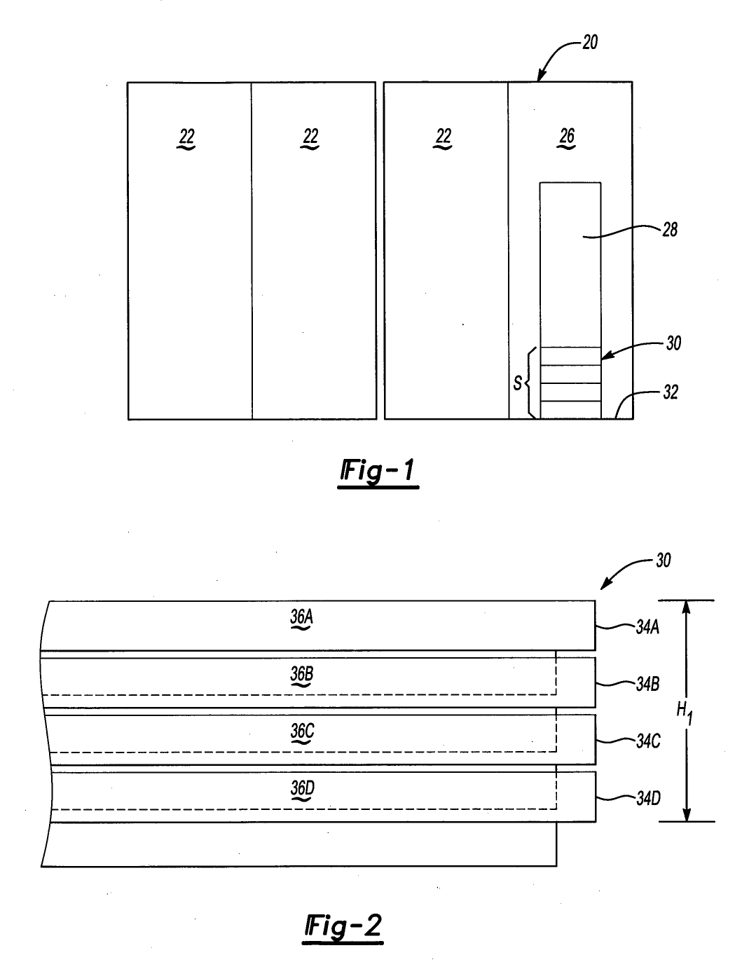

FIG. 1 schematically illustrates selected portions of an elevator cab 20. In this example, the cab 20 includes elevator car doors 22 that are moveable in a known manner for allowing access to the interior of the elevator cab. One wall portion 24 is on one side of the doors 22 while another wall portion 26 is on an opposite side of the doors 22. In this example, a car operating panel 28 is provided on the wall portion 26. The car operating panel 28 allows passengers to select a desired destination, for example.

A wall panel 30 is positioned between the car operating panel 28 and a floor 32 of the elevator cab 20. When the car operating panel 28 is installed, there is a space S between the car operating panel 28 and a nearby surface in the elevator cab such as the surface of the floor 32. The wall panel 30 covers the space S and provides a finished surface in the space S. When the example wall panel 30 is installed, there is no need to do anything more to finish off the space S.

The wall panel 30 has a selectively adjustable outside dimension for accommodating spaces S of different sizes in different elevator cabs. The space S may vary between a bottom, for example, of the car operating panel 28 and the floor 32 of the elevator cab among different elevator cabs. The example wall panel 30 facilitates economical assembly and installation of the elevator cab 20 by providing the ability to readily fill the space S and cover it with a finished surface provided by the wall panel 30.

It should be noted that the space S shown in FIG. 1 is illustrated for discussion purposes. The relative proportions or dimensions of the different features of the illustrated elevator cab 20 may be different than what is shown in the illustration. For example, the dimensions of the car operating panel 28 relative to the wall portion 26 may be different. The size of the space S may be, for example, on the order of 10 to 15 millimeters high and 500 millimeters wide when viewed from inside the elevator cab.

As can be appreciated from FIG. 2, the wall panel 30 comprises a plurality of panel members 34. The illustration shows four panel members 34A, 34B, 34C and 34D. A different number of panel members may be included in other examples of the wall panel 30. In FIG. 2 the panel members 34 are compressed relatively tightly together to establish a first outside dimension H1. In this first, contracted position, a plurality of primary panel portions 36A, 36B, 36C and 36D establish a finish surface for covering a space S that has a size corresponding to the first outside dimension H1. In the contracted position shown in FIG. 2, the primary panel portions 36 are received adjacent each other and collectively provide the finish surface used to cover the space S.

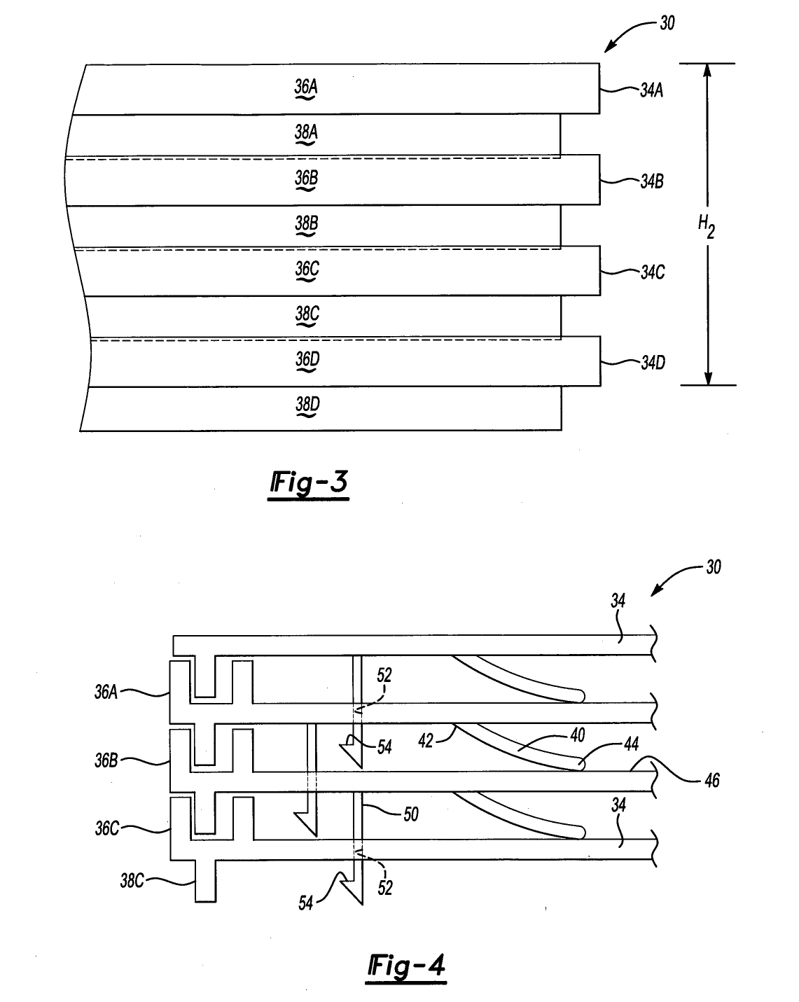

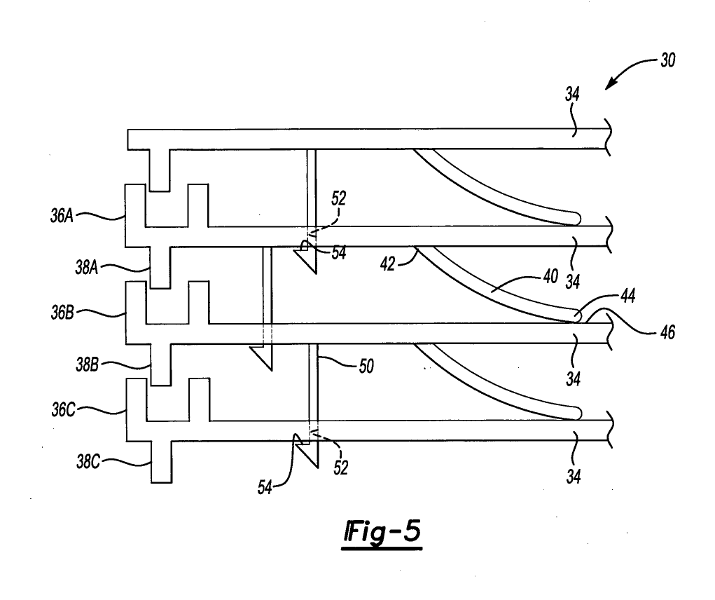

FIG. 3 shows the panel members 34 in a second, expanded position. As shown in FIG. 3, the panel members 34 include the primary panel portions 36 and secondary panel portions 38A, 38B, 38C and 38D, respectively. In the expanded position of FIG. 3, the primary panel portions 36 and the secondary panel portions 38 collectively establish a second, larger outside dimension H2.

By comparing FIGS. 2 and 3 it is possible to see how the wall panel 30 is adjustable to accommodate different dimensions of the space S between a car operating panel 28 and a nearby surface in an elevator cab to cover that space and provide a finished surface across it. In the example of FIG. 3, the primary panel portions 36 and the secondary panel portions 38 provide the finished surface when the wall panel 30 is correctly positioned within the elevator cab.

In the example of FIGS. 2 and 3, the wall panel members 34 are automatically moveable from the contracted position shown in FIG. 2 to the expanded position shown in FIG. 3. FIG. 4 schematically illustrates one example arrangement for providing such automatic movement. A plurality of biasing members 40 selectively urge the panel members 34 away from each other into the expanded position of FIG. 3. In this example, the biasing members 40 comprise springs having a first end 42 secured to one of the panel members and a second end 44 received against a reaction surface 46 on an adjacent one of the panel members. In one example, the panel members 34 and the springs 40 are integrally formed together as a single piece. One example embodiment includes plastic panel members 34 and plastic springs 40.

The illustrated example includes limiting members for limiting an amount of expansion or adjustment of the panel members 34 relative to each other. Each of the limiting members in this example includes a stem 50 that is connected to one of the panel members 34. The stem 50 is at least partially received through a slot 52 in an adjacent one of the panel members 34. As the panel members 34 are moveable relative to each other, the stem 50 moves through the slot 52.

Each of the example limiting members includes a stop surface 54 that is received against a reaction surface 56 on the adjacent one of the panel members 34 when the biasing members 40 are urging the panel members 34 away from each other a furthest possible distance established by the length of the stems 50.

As can be appreciated from the illustrations, the example wall panel 30 accommodates a variety of sizes of space S between a car operating panel 28 and a nearby surface in an elevator cab. Various expanded positions are possible between the contracted position in which the primary panel portions 36 are received adjacent to and tightly against each other in one example and a furthest expanded position in which the primary panel portions 36 are spaced apart from each other a maximum desired distance in the expanded position, the secondary panel portions 38 cover the distance between adjacent primary panel portions 36.

Installing the example wall panel 30 is a relatively easy task according to an example embodiment. The panel members 34 are compressed relative to each other against the bias of the biasing members 40 into the retracted position shown in FIG. 2, for example. The wall panel 30 is then positioned within the elevator cab between the car operating panel 28 and the nearby surface such as the floor 32. The panel members 34 are then allowed to automatically move relative to each other by action of the biasing members 40 until the panel members 34 have moved into an expanded position having an outside dimension that is approximately equal to the corresponding dimension of the space S. In other words, the wall panel members 34 automatically move into a position relative to each other for covering over the space S and providing a finished surface within the elevator cab between the car operating panel 28 and the nearby surface such as the floor 32.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator cab wall panel, comprising:
a plurality of panel members that are selectively moveable relative to each other to adjust a size of the panel for selectively covering a space between a car operating panel and a nearby surface in an elevator cab and providing a finish wall surface in the space.

2. The elevator cab wall panel of claim 1, wherein the panel members are moveable relative to each other between a contracted position in which the wall panel has a first outside dimension and an expanded position in which the wall panel has a second, larger outside dimension.

3. The elevator cab wall panel of claim 2, wherein
the panel members each comprise a primary panel portion and a secondary panel portion;
the primary panel portions are received adjacent each other and collectively provide the finish surface when the panel members are in the contracted position; and
the primary panel portions and the secondary panel portions collectively provide the finish surface when the panel members are in the expanded position.

4. The elevator cab wall panel of claim 2, wherein the panel members are selectively moveable into a plurality of expanded positions between the contracted position and a furthest expanded position.

5. The elevator cab wall panel of claim 2, comprising
a plurality of biasing members that bias the panel members toward the expanded position.

6. The elevator cab wall panel of claim 5, wherein the biasing members comprise springs that urge the panel members away from each other.

7. The elevator cab wall panel of claim 5, comprising
a plurality of stop members that limit an amount of movement of one of the panel members away from an adjacent one of the panel members.

8. The elevator cab wall panel of claim 7, wherein the stop members comprise a stem having one end secured to the one of the panel members, the stem being at least partially received through a slot on the adjacent one of the panel members, each of the stop members comprising a stop surface that is received against the adjacent one of the panel members for establishing a furthest extent that a corresponding one of the biasing members urges the one of the panel members away from the adjacent one of the biasing members.

9. An elevator cab, comprising:
a floor;
a ceiling above the floor;
a plurality of walls between the floor and the ceiling;
a car operating panel supported on one of the walls with a space adjacent the car operating panel between the car operating panel and at least one of the floor or the ceiling; and
a wall panel comprising a plurality of panel members that are selectively moveable relative to each other to adjust a size of the wall panel for selectively covering the space adjacent the car operating panel and providing a finish wall surface in the space.

10. The elevator cab of claim 9, wherein the panel members are moveable relative to each other between a contracted position in which the wall panel has a first outside dimension and an expanded position in which the wall panel has a second, larger outside dimension.

11. The elevator cab of claim 10, wherein
the panel members each comprise a primary panel portion and a secondary panel portion;
the primary panel portions are received adjacent each other and collectively provide the finish surface when the panel members are in the contracted position; and
the primary panel portions and the secondary panel portions collectively provide the finish surface when the panel members are in the expanded position.

12. The elevator cab of claim 10, wherein the panel members are selectively moveable into a plurality of expanded positions between the contracted position and a furthest expanded position.

13. The elevator cab of claim 10, comprising
a plurality of biasing members that bias the panel members toward the expanded position.

14. The elevator cab of claim 13, wherein the biasing members comprise springs that urge the panel members away from each other.

15. The elevator cab of claim 13, comprising
a plurality of stop members that limit an amount of movement of one of the panel members away from an adjacent one of the panel members.

16. The elevator cab of claim 15, wherein the stop members comprise a stem having one end secured to the one of the panel members, the stem being at least partially received through a slot on the adjacent one of the panel members, each of the stop members comprising a stop surface that is received against the adjacent one of the panel members for establishing a furthest extent that a corresponding one of the biasing members urges the one of the panel members away from the adjacent one of the biasing members.

17. The elevator cab of claim 9, wherein the panel members automatically move into an expanded position corresponding to the wall panel covering the space.

18. A method of covering a space between a car operating panel and a nearby surface in an elevator cab, comprising the steps of:
positioning a plurality of panel members between the car operating panel and the nearby surface; and
allowing the panel members to move relative to each other until the panel members cover the space and provide a finish surface for covering the space.

19. The method of claim 18, comprising
urging the panel members together into a retracted position in which the panel members collectively establish a first outside dimension that is at most equal to a corresponding dimension of the space;
placing the panel members between the car operating panel and the nearby surface when the panel members are in the retracted position; and
allowing the panel members to automatically move into an expanded position in which the panel member collectively establish a second, larger outside dimension approximately equal to the corresponding dimension of the space.
